(19) United States
(12) Patent Application Publication
(10) Pub. No.: US 2022/0396595 A1
(43) Pub. Date: Dec. 15, 2022

(54) A METAL COMPLEX AND USE THEREOF

(71) Applicant: RHODIA OPERATIONS, Lyon (FR)

(72) Inventors: Bing Hong, Shanghai (CN); Galder Cristobal, Singapore (SG); Stephane Streiff, Shanghai (CN); Katerina Karagianni, Paris (FR)

(73) Assignee: RHODIA OPERATIONS, Lyon (FR)

(21) Appl. No.: 17/770,003

(22) PCT Filed: Oct. 15, 2020
(86) PCT No.: PCT/CN2020/121025

§ 371 Date: Apr. 18, 2022

(30) Foreign Application Priority Data
Oct. 17, 2019 (CN) PCT/CN2019/111589

(51) Int. Cl. C07F 13/00; C11D 3/39; C11D 11/00; C08G 63/82; C08G 63/91; C09D 167/08

(52) U.S. Cl. CPC C07F 13/005; C11D 3/3932; C11D 3/3942; C11D 11/0017; C11D 11/0023; C08G 63/826; C08G 63/91; C09D 167/08

(57) ABSTRACT

Provided are new metal complexes having phenolic and macrocyclic amino ligands as well as to their use, in particular use for bleaching catalyst for detergent compositions and oxidative crosslinking catalyst for resins, containing said metal complexes. A formulation comprises at least a detergent, a metal complex, and optionally a source of hydrogen peroxide.

### CROSS-REFERENCE TO RELATED APPLICATIONS

This application claims priority filed on 17 Oct. 2019 in international procedure with number PCT/CN2019/111589, the whole contents of which are incorporated herein by reference for all purposes.

### TECHNICAL FIELD

The invention relates to a metal complex comprising a phenolic ligand and a macrocyclic N-containing ligand and its applications thereof.

### BACKGROUND

The following discussion of the prior art is provided to place the invention in an appropriate technical context and enable the advantages of it to be more fully understood. It should be appreciated, however, that any discussion of the prior art throughout the specification should not be considered as an express or implied admission that such prior art is widely known or forms part of common general knowledge in the field.

Peroxide compounds which dissolve in water to liberate hydrogen peroxide, such as sodium perborate and sodium percarbonate, have been used for a long time as oxidizing agents for disinfection and bleaching purposes. Such agents are effective in removing stains, such as tea, fruit and wine stains, from clothing at or near boiling temperatures. The oxidation effect of these substances is heavily dependent, in dilute solutions, on the temperature. The efficacy of peroxide bleaching agents drops off sharply at temperatures below 60° C.

At lower temperatures, the oxidation effect of the inorganic peroxygen compounds can be improved by adding so-called bleach activators. For example, the commonly used tetraacetyl ethylenediamine (TAED) converts the hydrogen peroxide and its derivatives to peracetic acid and makes the bleaching efficient at temperature down to 40° C. as described in EP0147191 A2. However, the large amount of usage and relative low reaction rate make the producer turn to other alternatives.

It is known that many transition metal containing catalysts help with the decomposition of H₂O₂ and H₂O₂-liberating percompounds, such as sodium percarbonate. It has also been suggested that transition metal salts in combination with a chelating agent can be used to activate peroxide compounds so as to make them usable for satisfactory bleaching at low temperature. The transition metal compound must not unduly promote peroxide decomposition by non-bleaching pathways and must be hydrolytically and oxidatively stable.

Hitherto the most effective peroxide bleach catalysts are based on iron, cobalt or manganese as the transition metal, such as manganese-triazacyclononane complexes described in US005244594A, manganese Schiff-Base complexes as described in EP1194514B1, manganese cross-bridged macrocyclic complexes as described in US2013261297, manganese complexes with 2,2′:6,2″-terpyridine as described in US005942152A, iron complexes with tris(pyridin-2-ylmethyl)amine (TPA) as described in US005850086A, iron complexes with pentadentate nitrogen-donor ligands as described in US2002149000A1 and cobalt complexes with polypyridineamine ligands as described in US2002066542A1. The addition of catalysts based on the transition metal cobalt is, however, a less acceptable route as judged either from an environmental point of view. On the other hand, the reported manganese complexes present the concerns, such as the low stability, high price and damage of textile.

There is still a need in the industry and it would be desirable to find alternative catalysts that are effective with better bleaching performances, are environment friendly and have a lower cost.

### SUMMARY OF THE INVENTION

In the course of endeavors to attain environmentally friendly and energy-saving washing and bleaching processes, application temperatures significantly below 60° C., in particular below 45° C., sometimes even down as low as cold-water temperature, have gained in importance in recent years. We have now discovered a new metal complex comprising a phenolic ligand and a macrocyclic N-containing ligand which fulfils the demands of stability, both during the washing process and in the dispenser of the washing machine and is extremely active, for catalyzing the bleaching action of a source of hydrogen peroxide on a wide variety of stains, notably at a temperature ranging from 10 to 70° C.

The present invention concerns then a metal complex having the general formula (I):

Mᵢ(L₁)(L₂)ᵢ (I)

wherein:
M is a transition metal;
   i is an integer ranging from 1 to 10;
L₁ is a phenolic ligand having the formula (II) or (III):

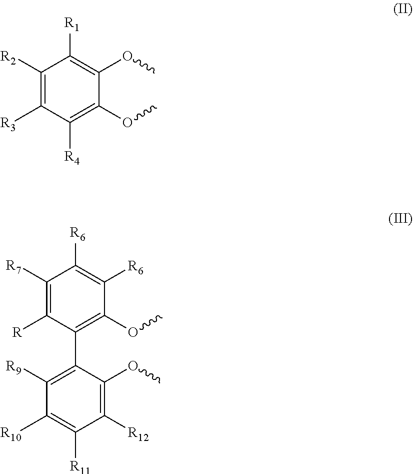

wherein:
R₁, R₂, R₃, R₄, R₅, R₆, R₇, R₈, R₉, R₁₀, R₁₁, or R₁₂, independently from each other, are selected from the group comprising: H, hydrocarbyl radical, halide, —OH, —NO₂, —CN, —OR′, —O—CO—R′, —COR′, —CO—OR′, —NR′R″, —CONR′R″, —NR′—COR″R′″, —NR′—CO—NR″R′″, —SO₃X, —SO₄X, —COOX, and at least one of R₁ to R₄, or one of R₅ to R₁₂ is selected from the group consisting of: —CN, —OR′, —O—CO—R′, —COR′, —CO—OR′, —NR′R″, —CONR′R″, —NR′—COR″R′″, —NR′—CO—NR″R′″, —SO₃X, —SO₄X or —COOX; or
five or six membered ring constituted with two or more groups of R₁, R₂, R₃, R₄ and the skeleton of aromatic ring; or
five or six membered ring constituted with two or more groups of R₅, R₆, R₇, R₈, R₉, R₁₀, R₁₁, R₁₂, optionally a —OH group, and the skeleton of aromatic ring;
R′, R″ and R′″, independently from each other, are H or hydrocarbyl radical;
X is selected from the group comprising H, alkali metal cation, alkaline earth metal cation or ammonium;
L₂ is a macrocyclic N-containing ligand having the formula (IV):

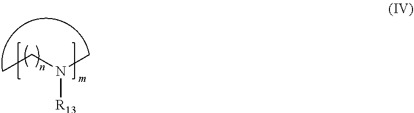

wherein:
R₁₃ is a hydrocarbyl radical, and each of the R₁₃ groups may be the same or different;
n is an integer being 1, 2 or 3;
m is an integer being 2, 3, 4 or 5.

We have also found that the metal complex of formula (I) can be used as a bleaching catalyst, which can enhance the bleaching effect of bleach or detergent compositions. In particular, it can enhance the bleaching effect of bleach or detergent composition comprising a source of hydrogen peroxide, such as peroxy compounds or peracids, especially for hydrophobic/lipophilic stains and also for hydrophilic/lipophobic stains, notably on textiles and hard surfaces such as porcelain and glass. It also appears that the composition of the present invention permits to obtain very good bleaching properties, higher stability of bleaching catalyst, and lower cost in comparison with other transition metal salts used on the market.

As used herein, the term “transition metal catalysts” refers to catalysts carrying a transition metal, such as notably iron, cobalt or manganese.

In the context of the present invention, bleaching should be understood as relating generally to the removal of stains or of other materials attached to or associated with a substrate. However, it is envisaged that the present invention can be applied where a requirement is the removal and/or neutralisation by an oxidative bleaching reaction of malodours or other undesirable components attached to or otherwise associated with a substrate. Furthermore, in the context of the present invention bleaching is to be understood as being restricted to any bleaching mechanism or process that does not require the presence of light or activation by light.

Another object of the invention is to provide an improved bleaching or textile or hard surface detergent composition which is effective at a temperature ranging from 10 to 70° C. Still another object of the invention is to provide new and improved bleaching or textile or hard surface detergent compositions which are especially effective for washing at lower temperatures. Yet another object of the invention is to provide a new and aqueous laundry or dish wash media containing new and improved detergent bleach formulations.

The present invention also concerns the use of a metal complex of formula (I) for treating a substrate, notably for bleaching a substrate. The present invention also concerns a method for treating a substrate, notably bleaching a substrate, comprising applying to the substrate, in an aqueous medium, a composition comprising at least a metal complex of formula (I).

The invention also concerns a method for washing tableware in a domestic automatic dishwashing appliance, comprising treating the stained tableware in an automatic dishwasher with a composition of the invention. The present invention also relates to automatic dishwashing rinse aid compositions and methods for treating tableware in a domestic automatic dishwashing appliance during a rinse cycle.

The invention concerns also a formulation comprising at least a detergent, a metal complex of formula (I), and optionally a source of hydrogen peroxide.

Other characteristics, details and advantages of the invention will emerge even more fully upon reading the description which follows.

### Definitions

For convenience, before further description of the present disclosure, certain terms employed in the specification, and examples are collected here. These definitions should be read in the light of the remainder of the disclosure and understood as by a person of skill in the art. The terms used herein have the meanings recognized and known to those of skill in the art, however, for convenience and completeness, particular terms and their meanings are set forth below.

The articles “a”, “an” and “the” are used to refer to one or to more than one (i.e., to at least one) of the grammatical object of the article.

The term “and/or” includes the meanings “and”, “or” and also all the other possible combinations of the elements connected to this term.

As used herein, “weight percent,” “wt %,” “percent by weight,” “% by weight,” and variations thereof refer to the concentration of a substance as the weight of that substance divided by the total weight of the composition and multiplied by 100.

It should be noted that in specifying any range of concentration, weight ratio or amount, any particular upper concentration, weight ratio or amount can be associated with any particular lower concentration, weight ratio or amount, respectively.

The terms “comprise” and “comprising” are used in the inclusive, open sense, meaning that additional elements may be included. Throughout this specification, unless the context requires otherwise the word “comprise”, and variations, such as “comprises” and “comprising”, will be understood to imply the inclusion of a stated element or step or group of element or steps but not the exclusion of any other element or step or group of element or steps.

The term “including” is used to mean “including but not limited to”. “Including” and “including but not limited to” are used interchangeably.

The term “consisting of” means the embodiment necessarily includes the listed components only and no other unlisted components are present.

Ratios, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a temperature range of 10° C. to 40° C. should be interpreted to include not only the explicitly recited limits of 10° C. to 40° C., but also to include sub-ranges, such as 15° C. to 35° C., 20° C. to 40° C., and so forth, as well as individual amounts, including fractional amounts, within the specified ranges, such as 12.2° C., 30.6° C., and 39.3° C., for example.

The term “between” should be understood as being inclusive of the limits.

It is specified that, in the continuation of the description, unless otherwise indicated, the values at the limits are included in the ranges of values which are given. It should be noted that in specifying any range of concentration, any particular upper concentration can be associated with any particular lower concentration.

As used herein, the term “hydrocarbyl” refers to a group mainly consisting of carbon atoms and hydrogen atoms, which group may be saturated or unsaturated, linear, branched or cyclic, aliphatic or aromatic. The term “hydrocarbyl” used in the description and the claims describes radicals which are based on hydrocarbons with the stated number of carbon atoms and which may be pure hydrocarbon radicals but may also have substituents or functions. Hydrocarbon groups of the present invention may be alkyl groups, alkenyl groups, alkynyl groups, aryl groups, alkylaryl groups, aryalkyl groups, heterocyclic groups, and/or alkylheterocyclic groups.

As used herein, the terminology “(Cₙ-Cₘ)” in reference to an organic group, wherein n and m are each integers, indicates that the group may contain from n carbon atoms to m carbon atoms per group.

As used herein, “alkyl” should be construed under the ordinary meaning. Alkyl groups include saturated hydrocarbons having one or more carbon atoms, including straight-chain alkyl groups, such as methyl, ethyl, propyl, butyl, pentyl, hexyl, heptyl, octyl, nonyl, decyl, cyclic alkyl groups (or “cycloalkyl” or “alicyclic” or “carbocyclic” groups), such as cyclopropyl, cyclopentyl, cyclohexyl, cycloheptyl, and cyclooctyl, branched-chain alkyl groups, such as isopropyl, tert-butyl, sec-butyl, and isobutyl, and alkyl-substituted alkyl groups, such as alkyl-substituted cycloalkyl groups and cycloalkyl-substituted alkyl groups. The term “aliphatic group” includes organic moieties characterized by straight or branched-chains, typically having between 1 and 22 carbon atoms. In complex structures, the chains may be branched, bridged, or cross-linked. Aliphatic groups include alkyl groups, alkenyl groups, and alkynyl groups.

As used herein, “alkenyl” or “alkenyl group” refers to an aliphatic hydrocarbon radical which can be straight or branched, containing at least one carbon-carbon double bond. Examples of alkenyl groups include, but are not limited to, ethenyl, propenyl, n-butenyl, i-butenyl, 3-methylbut-2-enyl, n-pentenyl, heptenyl, octenyl, decenyl, and the like. The term “alkynyl” refers to straight or branched chain hydrocarbon groups having at least one triple carbon to carbon bond, such as ethynyl.

The term “aryl” or “aryl group” includes unsaturated and aromatic cyclic hydrocarbons as well as unsaturated and aromatic heterocycles containing one or more rings. Aryl groups may also be fused or bridged with alicyclic or heterocyclic rings that are not aromatic so as to form a polycycle, such as tetralin. An “arylene” group is a divalent analog of an aryl group.

The term “heterocyclic” includes closed ring structures analogous to carbocyclic groups in which one or more of the carbon atoms in the ring is an element other than carbon, for example, nitrogen, sulfur, or oxygen. Heterocyclic groups may be saturated or unsaturated. Additionally, heterocyclic groups, such as pyrrolyl, pyridyl, isoquinolyl, quinolyl, purinyl, and furyl, may have aromatic character, in which case they may be referred to as “heteroaryl” or “heteroaromatic” groups.

### Details of the Invention

Those skilled in the art will be aware that the present disclosure is subject to variations and modifications other than those specifically described. It is to be understood that the present disclosure includes all such variations and modifications. The disclosure also includes all such steps, features, compositions and compounds referred to or indicated in this specification, individually or collectively and any and all combinations of any or more of such steps or features.

### Metal Complex

The metal complex has the general formula (I):

Mᵢ(L₁)(L₂)ᵢ (I)

wherein:
M is a transition metal;
   i is an integer ranging from 1 to 10;
Lᵢ is a ligand having the general formula (II) or (III):

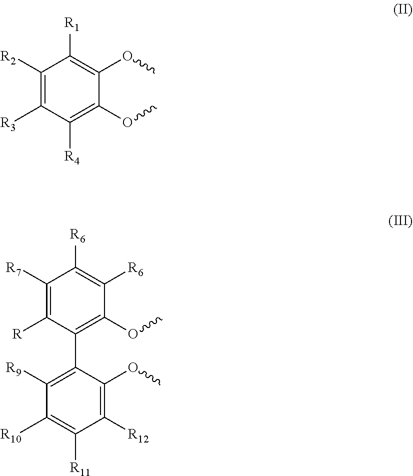

wherein:
R₁, R₂, R₃, R₄, R₅, R₆, R₇, R₈, R₉, R₁₀, R₁₁, or R₁₂, independently from each other, are selected from the group comprising: H, hydrocarbyl radical, halide, —OH, —NO₂, —CN, —OR′, —O—CO—R′, —COR′, —CO—OR′, —NR′R″, —CONR′R″, —NR′—COR″R′″, —NR′—CO—NR″R′″, —SO₃X, —SO₄X, —COOX, and at least one of R₁ to R₄, or one of R₅ to R₂ is selected from the group consisting of: —CN, —OR′, —O—CO—R′, —COR′, —CO—OR′, —NR′R″, —CONR′R″, —NR′—COR″R′″, —NR′—CO—NR″R′″, —SO₃X, —SO₄X or —COOX; or
five or six membered ring constituted with two or more groups of R₁, R₂, R₃, R₄ and the skeleton of aromatic ring; or
five or six membered ring constituted with two or more groups of R₅, R₆, R₇, R₈, R₉, R₁₀, R₁₁, R₁₁, optionally a —OH group, and the skeleton of aromatic ring;
R′, R″ and R′″, independently from each other, are H or hydrocarbyl radical;
X is selected from the group comprising H, alkali metal cation, alkaline earth metal cation or ammonium.

In some embodiments, i is selected as the integer 1, 2, 3, 4, 5, 6, 7, 8, 9 or 10.

In some embodiments, R₁, R₂, R₃, R₄, R₅, R₆, R₇, R₈, R₉, R₁₀, R₁₁, or R₁₁, independently from each other, are selected from the group comprising H, hydrocarbyl radical, —OH, —OR′, —O—CO—R′, —COR′, —CO—OR′, —CONR′R″, —SO₃X, —SO₄X or —COOX. Said hydrocarbyl radical is C₁-C₃₀ alkyl, alkenyl radical and preferably C₁-C₅ alkyl, alkenyl radical.

In some embodiments, R₁, R₂, R₃, R₄, R₅, R₆, R₇, R₈, R₉, R₁₀, R₁₁ or R₁₂, independently from each other, are selected from the group comprising H, hydrocarbyl radical, —OH, —COR′, —CO—OR′, —SO₃X or —COOX. Said hydrocarbyl radical is C₁-C₃₀ alkyl, alkenyl radical and preferably C₁-C₅ alkyl, alkenyl radical.

In some embodiments, R₁, R₂, R₃, R₄, R₅, R₆, R₇, R₈, R₉, R₁₀, R₁₁ or R₁₂, independently from each other, are selected from the group comprising —COR′, —O—CO—R′, —CO—OR′, —CONR′R″, —NR′—COR″R′″, —NR′—CO—NR″R′″, —SO₃X, —SO₄X, —COOX, —NO2, —CN.

In some embodiments, five or six membered ring (such as heterocyclic, aliphatic or aromatic ring) is constituted with two or more groups of R₁, R₂, R₃, R₄ and the skeleton of aromatic ring of formula (II), optionally comprising at least one of substituents or substructures, such as on the ring, selected from the group consisting of or essentially consisting of: —CN, —OR′, —O—CO—R′, —COR′, —CO—OR′, —NR′R″, —CONR′R″, —NR′—COR″R′″, —NR′—CO—NR″R′″, —SO₃X, —SO₄X or —COOX.

In some embodiments, five or six membered ring (such as heterocyclic, aliphatic or aromatic ring) is constituted with two or more groups of R₅, R₆, R₇, R₈, R₉, R₁₀, R₁₁, R₁₂, optionally a —OH group, and the skeleton of aromatic ring of formula (III), optionally comprising at least one of substituents or substructures, such as on the ring, selected from the group consisting of or essentially consisting of: —CN, —OR′, —O—CO—R′, —COR′, —CO—OR′, —NR′R″, —CONR′R″, —NR′—COR″R′″, —NR′—CO—NR″R′″, —SO₃X, —SO₄X or —COOX.

In some embodiments, L₁ can be selected from the deprotonated form of the group comprising: sodium 3,4-dihydroxybenzenesulfonate; 3,4-dihydroxybenzoic acid; 3,4-dihydroxy-N-methylbenzamide; ethyl 3,4-dihydroxybenzoate; sodium 6,7-dihydroxynaphthalene-2-sulfonate; sodium 6,7-dihydroxynaphthalene-1,3-disulfonate; sodium 6,7-dihydroxynaphthalene-1,3-dicarboxylate; sodium 6,7-dihydroxyquinoline-3-carboxylate; 6,7-dihydroxy-2H-chromen-2-one; (E)-3-(3,4-dihydroxyphenyl)acrylic acid; sodium 6,6′-dihydroxy-[1,1′-biphenyl]-3,3′-disulfonate; sodium 2′,6-dihydroxy-[1,1′-biphenyl]-3-sulfonate; sodium 2,2′-dihydroxy-[1,1′-binaphthalene]-5-sulfonate; 2,2′-dihydroxy-[1,1′-binaphthalene]-5-carboxylic acid; Methyl 2,2′,5′,6′-tetrahydroxy-[1,1′-binaphthalene]-5-carboxylate; Ellagic acid.
L₂ is a ligand having the formula (IV):

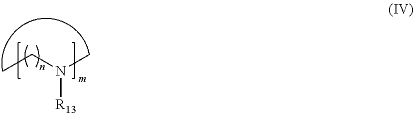

wherein:
R₁₃ is a hydrocarbyl radical, and each of the R₁₃ groups may be the same or different;
n is an integer being 1, 2 or 3;
m is an integer being 2, 3, 4 or 5.

R₁₃ may be a C₁-C₃₀-hydrocarbyl radical, preferably a C₁-C₁₅-hydrocarbyl radical.

R₁₃ may notably be C₁₋₃₀-alkyl radicals, preferably C₁₋₂₀-alkyl radicals, particularly preferably C₁₋₁₀-alkyl radicals, which can be straight-chain or branched and may carry one or more substituents. R₁₃ may be C₂₋₃₀-alkenyl radicals, preferably C₂₋₂₀-alkenyl radicals, particularly preferably C₂₋₁₀-alkenyl radicals, which can be straight-chain or branched and may carry one or more substituents and/or one or more functions. R₁₃ may also be C₅₋₁₈-cycloalkyl radicals which may have branches. R₁₃ may furthermore be C₇₋₁₈-aralkyl radicals in which an aromatic radical is bonded via an alkyl group to the amine nitrogen atom. R₁₃ may also be C₇₋₁₈-heteroalkyl radicals or C₆₋₁₈-aryl radicals or C₃₋₁₈-heteroaryl radicals, with, in the last-mentioned compounds, an aromatic radical being directly linked to the amine nitrogen atom.

R₁₃ may furthermore carry one or more, preferably zero or one, substituents such as hydroxyl groups, C₁₋₄-alkoxy radicals, amino groups, C₁₋₄-alkylamino radicals, (di-C₁₋₄-alkyl)amino radicals, chlorine atoms, bromine atoms, nitro groups, cyano groups, C₁₋₄-alkylthio radicals, C₁₋₄-alkylsulfonyl radicals, carbonyl radicals, carboxyl groups, sulfo groups, sulfate groups, carboxy-C₁₋₄-alkyl radicals, carbamoyl radicals or phenyl, tolyl or benzyl radicals.

The carbon chains of R₁₃ may furthermore be interrupted by oxygen atoms, imino groups, C₁₋₄-alkylimino radicals, iminocarbonyl radicals, oxycarbonyl radicals or carbonyl radicals.

R₁₃ is preferably a C₁₋₅-hydrocarbyl radical, preferably a methyl radical.

L₂ having the general formula (IV) may be chosen in the group constituted by triazacycloalkanes and tetraazacycloalkanes.

L₂ having the general formula (IV) may be chosen in the group constituted by: 1,3,5-trimethyl-1,3,5-triazacyclohexane; 1,3,5-trimethyl-1,3,5-triazepane; 1,3,5-trimethyl-1,3,5-triazocane; 1,3,5,7-tetramethyl-1,3,5-triazocane; 1,3,6-trimethyl-1,3,6-triazocane; 1,3,5-trimethyl-1,3,5-triazonane; 1,3,6-trimethyl-1,3,6-triazonane; 1,3,6,8-tetramethyl-1,3,6-triazonane; 1,4,7-trimethyl-1,4,7-triazacyclononane; 1,3,5-trimethyl-1,3,5-triazecane; 1,3,6-trimethyl-1,3,6-triazecane; 1,3,7-trimethyl-1,3,7-triazecane; 1,3,5,7-tetramethyl-1,3,7-triazecane; 1,3,5,7,9-pentamethyl-1,3,7-triazecane; 1,3,5,7-tetramethyl-1,3,5-triazecane; 1,4,7-trimethyl-1,4,7-triazecane; 1,4,7,9-tetramethyl-1,4,7-triazecane; 1,4,7-trimethyl-1,4,7-triazacycloundecane; 1,4,8-trimethyl-1,4, 8-triazacycloundecane; 1,4,6,8-tetramethyl-1,4,8-triazacycloundecane; 1,4,7-trimethyl-1,4,7-triazacyclododecane; 1,4,7,10-tetramethyl-1,4,7,10-tetraazacyclododecane; 1,4,7,10-tetramethyl-1,4,7-triazacyclododecane; 1,4,8-trimethyl-1,4,8-triazacyclododecane; 1,5,9-trimethyl-1,5,9-triazacyclododecan; 1,3,5,9-tetramethyl-1,5,9-triazacyclododecane; and 2-methyl-1,4,7-trimethyl-1,4,7-triazacyclononane.

According to one embodiment, L₂ is preferably 1,4,7-trimethyl-1,4,7-triazacyclononane.

As used herein, metals of group IB, JIB, IIIB, IVB, VB, VIB, VIIB and VIIIB are often referred to as transition metals. This group comprises the elements with atomic number 21 to 30 (Sc to Zn), 39 to 48 (Y to Cd), 72 to 80 (Hf to Hg) and 104 to 112 (Rf to Cn).

As above defined, M is a transition metal. The transition metal can be in the form of atom or ion. Preferably, the transition metal is selected from the group consisting of: V, Mn, Fe, Co, Ni and Cu, more preferably Mn and Fe and most preferably Mn.

When the transition metal is in the form of ion, preference is given to using complexes with one or more transition metal atoms in oxidation states +1, +2, +3, +4, +5, +6 or +7.

The metal complex can be prepared by using a metal compound and a phenolic ligand and a macrocyclic N-containing ligand. The metal compound is preferably a salt, for example a metal halide. The preparation methods can be very conventional. In a typical method, ligands are introduced onto the metal compound by substitution. The metal salt may be used in the form of powder as it is, or may be dissolved or dispersed in the solvent to be used. Some transition metal complexes, or the ligand compounds used as starting materials, are sensitive to air or oxygen, the preparation reaction is therefore preferably performed under oxygen-free conditions, such as under the protection of nitrogen gas.

The preparation method of the metal complex comprising the following steps:

a) mixing the metal compound with macrocyclic N-containing ligand;

b) preparing a solution comprising phenolic ligand;

c) adding the solution prepared by step b) to the mixture prepared by step a);

d) heating the mixture obtained at step c) at a temperature for reaction.

The metal complex is prepared by mixing metal compound, ligand Lᵢ and ligand L₂ with molar ratio of t:1:t, wherein t is ranging from the number of 1 to 10. The molar ratio of the metal compound to macrocyclic N-containing ligand is 1:1. The molar ratio of the metal compound to phenolic ligand is from 10:1 to 1:1.

The solvent in step b) is readily chosen on the basis of the relative solubility of the ligands and the metal compounds. The preferred solvent is alcohol, water or their combination.

The temperature in step d) is preferably 0 to 100° C., more preferably 20-60° C. The reaction time preferably is 1 to 24 hours, more preferably 2 to 10 hours, even more preferably 4 to 8 hours.

### Composition

The inventions also concern a composition comprising at least:

(1) a metal complex of formula (I) as above mentioned;

(2) a source of hydrogen peroxide.

The composition of the invention, notably bleach or textile detergent composition may be formulated by combining effective amounts of the components. The term “effective amounts” as used herein means that the ingredients are present in quantities such that each of them is operative for its intended purpose when the resulting mixture is combined with water to form an aqueous medium which can be used to wash and clean clothes, fabrics and other articles.

Hydrogen peroxide sources are well known in the art and they usually refer to peroxide, hydrogen peroxide-liberating or -generating compounds. Source of hydrogen peroxide is preferably chosen in the group constituted by: alkali metal peroxides, organic peroxides, such as urea peroxide or PAP (6-phthalimido peroxy hexanoic acid commercialized by Solvay under the brand name Eureco™), inorganic persalts, such as the alkali metal perborates, percarbonates, perphosphates, persulphates and peroxyacids and their salts, and their precurors. Mixtures of two or more such compounds may also be suitable. Particularly preferred are sodium percarbonate and sodium perborate and, especially, sodium perborate monohydrate. Sodium perborate monohydrate is preferred to tetrahydrate because of its excellent storage stability while also dissolving very quickly in aqueous bleaching solutions. Sodium percarbonate may be preferred for environmental reasons.

Hydrogen peroxide sources may be in the form of solid particles.

In one embodiment, the metal complex of formula (I) of the invention may be coated on solid particles source of hydrogen peroxide, such as solid particles of sodium percarbonate.

In the context of the present invention, by “coated” it means in fact that the metal complex of formula (I) is incorporated in a coating layer i.e. a layer of a solid coating composition comprising the metal complex of formula (I) and optionally a carrier which may be an organic or an inorganic compound (or a mixture of both organic and inorganic compounds); and eventually other ingredients.

Generally speaking, a “coating” is a covering that is applied to the surface of an object, usually referred to as the substrate. In the frame of the invention, it means hence a covering layer that may be applied to the solid particles source of hydrogen peroxide as they are, or that may be applied to such particles already bearing a coating.

Thus the present invention also relates to solid bleach particles comprising:

a) a metal complex of formula (I) as above mentioned; and

b) solid particles source of hydrogen peroxide, preferably solid particles of sodium percarbonate.

wherein the metal complex of formula (I) is coated on the solid particles source of hydrogen peroxide.

To prepare solid bleach particles as described previously, said metal complex of formula (I) may typically be applied on the solid particles source of hydrogen peroxide by spray coating or by melt coating.

The solid bleach particles may generally contain at least 65 wt % of the solid particles source of hydrogen peroxide, more preferably at least 85 wt % and even more preferably, at least 90 wt %.

These bleaching compounds may be utilized alone or in conjunction with a peroxyacid bleach precursor.

The peroxy compound bleaches which can be utilized in the present invention include hydrogen peroxide, hydrogen peroxide-liberating compounds, hydrogen peroxide-generating systems, peroxyacids and their salts, and peroxyacid bleach precursors and mixtures complexes.

Peroxyacid bleach precursors are known and amply described in literature, such as in the GB Patents 836,988; 864,798; 907,356; 1,003,310 and 1,519,351; German Patent 3,337,921; EP-A-0185522; EP-A-0174132; EP-A-0120591; and U.S. Pat. Nos. 1,246,339; 3,332,882; 4,128,494; 4,412,934 and 4,675,393.

Another useful class of peroxyacid bleach precursors is that of the quaternary ammonium substituted peroxyacid precursors as disclosed in U.S. Pat. Nos. 4,751,015 and 4,397,757, in EP-A-284292 and EP-A-331,229. Examples of peroxyacid bleach precursors of this class are: 2-(N,N,N-trimethyl ammonium) ethyl sodium-4-sulphophenyl carbonate chloride—(SPCC); N-octyl,N,N-dimethyl-N10-carbophenoxy decyl ammonium chloride—(ODC); 3-(N,N,N-trimethyl ammonium) propyl sodium-4-sulphophenyl carboxylate; and N,N,N-trimethyl ammonium toluyloxy benzene sulphonate.

Of the above classes of peroxyacid bleach precursors, the preferred classes are the esters and amide, including acyl phenol sulphonates and acyl alkyl phenol sulphonates; acylamides; and the quaternary ammonium substituted peroxyacid precursors.

Highly preferred peroxyacid precursors (activators of peroxides) include sodium-4-benzoyloxy benzene sulphonate; N,N,N′,N′-tetraacetyl ethylene diamine; sodium-1-methyl-2-benzoyloxy benzene-4-sulphonate; sodium-4-methyl-3-benzoyloxy benzoate; SPCC; trimethyl ammonium toluyloxy benzene sulphonate; sodium nonanoyloxybenzene sulphonate and sodium 3,5,5,-trimethyl hexanoyloxybenzene sulphonate.

Organic peroxyacids may also be suitable as the peroxy bleaching compound, such as monoperoxy acids and diperoxyacids.

Typical monoperoxy acids useful herein include, for example: peroxybenzoic acid and ring-substituted peroxybenzoic acids, eg peroxy-.alpha.-naphthoic acid; aliphatic, substituted aliphatic and arylalkyl monoperoxyacids, e.g. peroxylauric acid, peroxystearic acid and N,N-phthaloylaminoperoxy caproic acid (PAP); and 6-octylamino-6-oxo-peroxyhexanoic acid.

Typical diperoxyacids useful herein include, for example: 1, 12-diperoxydodecanedioic acid (DPDA), 1,9-diperoxyazelaic acid, diperoxybrassilic acid; diperoxysebasic acid and diperoxyisophthalic acid; 2-decyldiperoxybutane-1,4-diotic acid; and 4,4′-sulphonylbisperoxybenzoic acid.

In particular, the composition can be formulated to contain, for example, from 1 to 50% by weight, preferably from 5 to 25% by weight, of source of hydrogen peroxide, with respect to the total weight of the composition. Peroxyacid precursors may be utilized in combination with a peroxide compound with the amount range from 1 to 25% by weight, preferably from 2 to 15% by weight.

Composition of the invention may then further comprise water.

The pH of the composition may be from 7 to 12, preferably from 9 to 11.

The composition of the invention may further comprise a detergent. Detergents are usually defined as a surfactant or a mixture of surfactants having cleaning properties in dilute solutions. The compounds of the invention are compatible with substantially any known and common surface-active agents and detergency builder materials. The surfactant may be naturally derived, such as soap, or a synthetic material selected from anionic, nonionic, amphoteric, zwitterionic, cationic actives and ‘mixtures thereof. Many suitable actives are commercially available and are amply described in literature. The total level of the surfactant may range up to 50% by weight, preferably being from 1 to 40% by weight of the composition, most preferably 2 to 25% by weight.

In general, the nonionic and anionic surfactants of the surfactant system may be chosen from the surfactants described “Surface Active Agents” Vol. 1, by Schwartz & Perry, Interscience 1949, Vol. 2 by Schwartz, Perry & Berch, Interscience 1958, in the current edition of “McCutcheon's Emulsifiers and Detergents” published by Manufacturing Confectioners Company or in “Tenside-Taschenbuch”, H. Stache, 2nd Edn., Carl Hauser Verlag, 1981.

Examples of suitable synthetic anionic detergent compounds are sodium and ammonium alkyl sulphates, especially those obtained by sulphating higher (C₈-C₁₈) alcohols produced, for example, from tallow or coconut oil; sodium and ammonium alkyl (C₉-C₂₀) benzene sulphonates, particularly sodium linear secondary alkyl (C₁₀-C₁₅) benzene sulphonates; sodium alkyl glyceryl ether sulphates, especially those esters of the higher alcohols derived from tallow or coconut oil and synthetic alcohols derived from petroleum; sodium coconut oil fatty acid monoglyceride sulphates and sulphonates; sodium and ammonium salts of sulphuric acid esters of higher (C₉-C₁₈) fatty alcohol alkylene oxide, particularly ethylene oxide, reaction products; the reaction products of fatty acids such as coconut fatty acids esterified with isethionic acid and neutralized with sodium hydroxide; sodium and ammonium salts of fatty acid amides of methyl taurine; alkane monosulphonates such as those derived by reacting alpha-olefins (C₈-C₂₀) with sodium bisulphite and those derived by reacting parafins with SO₂ and Cl₂ and then hydrolyzing with a base to produce a random sulphonate; sodium and ammonium C₇-C₂ dialkyl sulfosuccinates; and olefin sulphonates, which term is used to describe the material made by reacting olefins, particularly C₁₀-C₂₀ alpha olefins with SO₃ and then neutralizing and hydrolysing the reaction product. The preferred anionic detergent compounds are sodium (C₁₁-C₁₅) alkylbenzene sulphonates, sodium (C₁₆-C₁₈) alkyl sulphates and sodium (C₁₆-C₁₈) alkyl ether sulphates.

Examples of suitable nonionic surfactant compounds which may be used, include in particular the reaction products of alkylene oxides, usually ethylene oxide, with alkyl (C₆-C₂₂) phenols, generally 5-25 EO, i.e. 5-25 units of ethylene oxides per molecule; the condensation products of aliphatic (C₈-C₁₈) primary or secondary linear or branched alcohols with ethylene oxide, generally 3-30 EO, and products made by condensation of ethylene oxide with the reaction products of propylene oxide and ethylene diamine. Other so-called nonionic surfactants include alkyl polyglycosides, long chain tertiary amine oxides, long chain tertiary phosphine oxides and dialkyl sulphoxides.

Soaps may also be incorporated in the compositions of the invention, preferably at a level of less than 25% by weight. They are particularly useful at low levels in binary (soap/anionic) or ternary mixtures together with nonionic or mixed synthetic anionic and nonionic compounds. Soaps which are used, are preferably the sodium, or, less desirably, potassium salts of saturated or unsaturated C₁₀-C₂₄ fatty acids or mixtures thereof. The amount of such soaps can be varied between 0.5 and 25% by weight, with lower amounts of 0.5 to 5% by weight being generally sufficient for lather control. Amounts of soap between 2 and 20% by weight, especially between 5 and 10% by weight, are used to give a beneficial effect on detergency. This is particularly valuable in compositions used in hard water when the soap acts as a supplementary builder.

The detergent compositions of the invention will normally also contain a detergency builder. Builder materials may be selected from calcium sequestrant materials, precipitating materials, calcium ion-exchange materials, such as aluminosilicates, silicates, carbonates and phosphates.

Examples of suitable inorganic builders are aluminosilicates with ion-exchanging properties, such as zeolites. Various types of zeolites are suitable, especially zeolites A, X, B, P, MAP and HS in their Na form, or in forms in which Na is partly replaced by other cations, such as Li, K, Ca, Mg or ammonium. Suitable zeolites are described, for example, in EP-A 038 591, EP-A 021 491, EP-A 087 035, U.S. Pat. No. 4 604 224, GB-A2 013 259, EP-A 522 726, EP-A 384 070 and WO 94/24 251.

Other suitable inorganic builders are, for example, amorphous or crystalline silicates, such as amorphous disilicates, crystalline disilicates such as the sheet silicate SKS-6 (manufactured by Essential Ingredients, Inc.). The silicates can be employed in the form of their alkali metal, alkaline earth metal or ammonium salts. Na, Li and Mg silicates are preferably employed.

These builder materials may be present at a level of, for example, from 5 to 80% by weight, preferably from 10 to 60% by weight.

The composition may also contain one or more bleach stabilizers. These comprise additives able to adsorb, bind or complex traces of heavy metals. Examples of additives which can be used according to the invention with a bleach-stabilizing action are polyanionic compounds, such as polyphosphates, polycarboxylates, polyhydroxypolycarboxylates, soluble silicates as completely or partially neutralized alkali metal or alkaline earth metal salts, in particular as neutral Na or Mg salts, which are relatively weak bleach stabilizers. Examples of strong bleach stabilizers which can be used according to the invention are complexing agents such as ethylenediaminetetraacetate (EDTA), nitrilotriacetic acid (NTA), methyl-glycinediacetic acid (MGDA), [beta]-alaninediacetic acid (ADA), ethylenediamnine-N,N′-disuccinate (EDDS) and phosphonates such as ethylenediaminetetramethylenephosphonate, diethylenetriaminepentamethylenephosphonate or hydroxyethylidene-1,1-diphosphonic acid in the form of the acids or as partially or completely neutralized alkali metal salts. The complexing agents are preferably employed in the form of their Na salts.

Apart from the components already mentioned, the compositions of the invention can contain any of the conventional additives in the amounts in which such materials are normally employed in fabric washing detergent compositions. Examples of these additives include leather boosters, such as alkanolamides, particularly the monoethanol amides derived from palmkernel fatty acids and coconut fatty acids, lather depressants, such as alkyl phosphates and silicones, anti-redeposition agents, such as sodium carboxymethyl cellulose and alkyl or substituted alkyl cellulose ethers, other stabilizers, such as ethylene diamine tetraacetic acid and the phosphonic acid derivatives, fabric softening agents, inorganic salts, such as sodium sulphate, and, usually present in very small amounts, fluorescent agents, perfumes, corrosion inhibitors, enzymes, such as proteases, cellulases, lipases, amylases and oxidases, germicides and colorants.

The detergent compositions of the present invention may additionally comprise one or more enzymes, which provide cleaning performance, fabric care and/or sanitation benefits. Said enzymes include oxidoreductases, transferases, hydrolases, lyases, isomerases and ligases. Suitable members of these enzyme classes are described in Enzyme nomenclature 1992: recommendations of the Nomenclature Committee of the International Union of Biochemistry and Molecular Biology on the nomenclature and classification of enzymes, 1992, ISBN 0-12-227165-3, Academic Press.

Compositions of the invention formulated as free-flowing particles, e.g. in powdered or granulated form, can be produced by any of the conventional techniques employed in the manufacture of detergent compositions, for instance by slurry-making, followed by spray-drying to form a detergent base powder to which the heat-sensitive ingredients can be added as dry substances.

It will be appreciated, however, that the compositions can itself be made in a variety of other ways, such as the so-called part-part processing, non-tower route processing, dry-mixing, agglomeration, granulation, extrusion, compacting and densifying processes etc., such ways being well known to those skilled in the art.

The compositions of the invention can also contain any of the conventional additives in the amounts in which such materials are normally employed in dishwashing compositions.

In some embodiments, the dishwashing compositions can comprise a chelator, such as the sodium citrate, EDTA, trisodium methylglycinediacetate (MGDA), Sodium tripolyphosphate, N,N-Dicarboxymethyl glutamic acid tetrasodium salt (GLDA).

In some embodiments, the dishwashing compositions can comprise a builder, such as sodium silicate, sodium carbonate.

In some embodiments, the dishwashing compositions can comprise a filler, such as sodium sulfate, ammonium sulfate.

In some embodiments, the dishwashing composition can comprise a bleach agent, such as the chlorine, hydrogen peroxide, sodium percabonate.

In some embodiments, the dishwashing composition can comprise an enzyme, such as the protease and amylase.

In some embodiments, the dishwashing composition can comprise a dispersant agent, such as the polyacrylate, polyethylene glycol.

In some embodiments, the dishwashing composition can comprise a surfactant, such as the non-ionic surfactants, anionic surfactants.

It should be understood by the skilled person the chelator, builder, filler, bleach agent, enzyme, dispersant and surfactant can be used solely or in the form of any combination for preparing the dishwashing composition.

Composition of the invention preferably comprises from 0.00001 to 1.0% by weight, preferably from 0.00001 to 0.5% by weight, more preferably from 0.0001 to 0.1% by weight of the metal complex of formula (I), with respect to the total weight of the composition; notably 0.00001, 0.00005, 0.0001, 0.0005, 0.001, 0.005, 0.01, 0.05, 0.1%, 0.5, and 1% by weight or any range comprised between these values.

The inventions also concern a resin composition comprising at least:

(1) a metal complex of formula (I) as above mentioned;

(2) a resin.

The resin can be selected from the group comprising alkyd resin or epoxy resin.

The alkyd resin typically consists of unsaturated fatty acids, polyols and phthalic anhydride.

Alicyclic epoxy resins or aromatic epoxy resins are common used, such as bisphenol A epoxy resins, bisphenol F epoxy resins and phenolic or cresol novolak epoxy resins are mentioned. Also, the aromatic epoxy resins obtained from various phenolic compounds can be used. Well-known epoxy resins having an average of more than 1 epoxy groups in the molecule may be employed. Epoxy resins in which the 1,2-epoxy groups are attached to different hetero atoms or functional groups. These compounds comprise the N,N,O-triglycidyl derivative of 4-aminophenol, the glycidyl ether-glycidyl ester of salicylic acid, N-glycidyl-N′-(2-glycidyloxypropyl)-5,5-dimethylhydantoin or 2-glycidyloxy-1,3-bis(5,5-dimethyl-1-glycidylhydantoin-3-yl)propane. The epoxy resin can be: polyglycidyl, poly(β-methylglycidyl) esters, poly-(N-glycidyl) compounds, cycloaliphatic epoxy resins.

The above-mentioned epoxy compounds are known and some are commercially available.

The resin composition can be prepared by mixing the metal complex of formula (I) as a the oxidative crosslinking catalyst with a resin composition for example containing an epoxy resin or alkyd resin compound, wherein the metal salt complex is mixed in an amount of 1 to 40 parts by weight per 100 parts by weight of an epoxy resin or alkyd resin as a solid content.

If necessary, other cure accelerators and fillers may be employed in combination with metal complex as above mentioned of the present invention.

### Applications

The present invention also concerns the use of a metal complex of formula (I) for treating a substrate, notably for bleaching a substrate. The present invention also concerns a method for treating a substrate, notably bleaching a substrate comprising applying to the substrate, in an aqueous medium, a composition comprising at least a metal complex of formula (I).

The present invention extends to a method of bleaching a substrate comprising applying to the substrate, in an aqueous medium, the bleaching composition according to the present invention.

Any suitable substrate that is susceptible to bleaching or one that one might wish to subject to bleaching may be used, such as a textile for instance. Preferably the textile is a laundry fabric or garment.

In a preferred embodiment, the method is carried out on a laundry fabric using an aqueous treatment liquor. In particular, the treatment may be effected in a wash cycle for cleaning laundry. More preferably, the treatment is carried out in an aqueous detergent bleach wash liquid.

The organic substances can be contacted with the textile fabric in any conventional manner. For example it may be applied in dry form, such as in powder form, or in a liquor that is then dried, for example in an aqueous spray-on fabric treatment fluid or a wash liquor for laundry cleaning, or a non-aqueous dry cleaning fluid or spray-on aerosol fluid.

In a particularly preferred embodiment the method according to the present invention is carried out on a laundry fabric using aqueous treatment liquor. In particular the treatment may be effected in, or as an adjunct to, an essentially conventional wash cycle for cleaning laundry. More preferably, the treatment is carried out in an aqueous detergent wash liquor. The organic substance can be delivered into the wash liquor from a powder, granule, pellet, tablet, block, bar or other such solid form. The solid form can comprise a carrier, which can be particulate, sheet-like or comprise a three-dimensional object. The carrier can be dispersible or soluble in the wash liquor or may remain substantially intact. In other embodiments, the organic substance can be delivered into the wash liquor from a paste, gel or liquid concentrate.

In the alternative, the organic substance can be presented in the form of a wash additive that preferably is soluble. The additive can take any of the physical forms used for wash additives, including powder, granule, pellet, sheet, tablet, block, bar or other such solid form or take the form of a paste, gel or liquid. Dosage of the additive can be unitary or in a quantity determined by the user. While it is envisaged that such additives can be used in the main washing cycle, the use of them in the conditioning or drying cycle is not hereby excluded.

The present invention is not limited to those circumstances in which a washing machine is employed, but can be applied where washing is performed in some alternative vessel. In these circumstances it is envisaged that the organic substance can be delivered by means of slow release from the bowl, bucket or other vessel which is being employed, or from any implement which is being employed, such as a brush, bat or dolly, or from any suitable applicator.

The invention also concerns a method washing tableware in a domestic automatic dishwashing appliance, comprising treating the stained tableware in an automatic dishwasher with a composition of the invention. The present invention also relates to automatic dishwashing rinse aid compositions and methods for treating tableware in a domestic automatic dishwashing appliance during a rinse cycle.

Automatic dishwashing with bleaching chemicals is different from fabric bleaching. In automatic dishwashing, use of bleaching chemicals involves promotion of soil removal from dishes, though soil bleaching may also occur. Additionally, soil anti-redeposition and anti-spotting effects from bleaching chemicals would be desirable. Some bleaching chemicals, (such as a hydrogen peroxide source, alone or together with tetraacetylethylenediamine, TAED) can, in certain circumstances, be helpful for cleaning dishware, but this technology gives far from satisfactory results in a dishwashing context: for example, ability to remove tough tea stains is limited, especially in hard water, and requires rather large amounts of bleach. Other bleach activators developed for laundry use can even give negative effects, such as creating unsightly deposits, when put into an automatic dishwashing product, especially when they have overly low solubility. Other bleach systems can damage items unique to dishwashing, such as silverware, aluminium cookware or certain plastics.

The composition of the invention may also be applied in the peroxide oxidation of a broad range of organic molecules such as olefins, alcohols, aromatic ethers, sulphoxides and various dyes, and also for inhibiting dye transfer in the laundering of fabrics.

The invention concerns also a formulation, notably a solid composition, comprising at least a detergent, a metal complex of formula (I), and optionally a source of hydrogen peroxide. Said composition may comprise from 0.00001 to 1%, preferably from 0.00001 to 0.5% by weight, more preferably from 0.0001 to 0.1% by weight of transition metal complex of formula (I), with respect to the total weight of the composition; notably 0.00001, 0.00005, 0.0001, 0.0005, 0.001, 0.005, 0.01, 0.05, 0.1%, 0.5, and 1% by weight or any range comprised between these values with respect to the total weight of the composition.

The invention also concerns a method for treating a substrate, notably for bleaching a substrate, comprising at least:
a) having available a composition comprising at least a detergent and a metal complex of formula (I), notably in a solid form,
b) having available a source of hydrogen peroxide, separate from the composition a)
c) bringing the composition a) extemporaneously into contact with source of hydrogen peroxide, notably under conditions favourable for the solubilization and/or dispersion of the composition a) in a liquid medium to obtain a mixture, and
d) bringing the mixture of c) into contact with the substrate.

The invention also concerns an extemporaneous composition comprising at least:
a first composition comprising at least a detergent and a metal complex of formula (I), notably in a solid form, and
a second composition comprising at least a source of hydrogen peroxide, separate from the first composition; the second composition being capable of being mixed with the first composition.

Such an extemporaneous composition may advantageously combine the first and second compositions separately, in a single packaging.

It has been surprisingly discovered by the applicants that the metal complex of the invention may be applied to resins as an oxidative crosslinking catalyst, for example, as curing an epoxy resin or alkyd resin in the applications of engineering and construction materials, insulating materials for electric and electronic parts, various moulded products, adhesives or coatings. The resin composition with the oxidative crosslinking catalyst comprising at least one of metal complexes of the invention can apparently dry much faster.

The dry reaction may be induced at room or elevated temperatures or it may be initiated, in the presence of appropriate fillers, by UV light. The specific dry procedure required to produce a cured resin of optimized performance characteristics is dependent upon the combination of resin, oxidative crosslinking catalyst and/or fillers.

The resin composition can be prepared by a certain resin as a powder composition, or as a liquid composition.

The invention also concerns a method for treating a substrate, notably for coating a substrate, comprising at least:
a) having available a composition comprising at least a resin and a metal complex of formula (I), notably in a solid form,
b) partially applying to the substrate with the composition a);
c) optionally curing the substrate obtained at step b) at a proper temperature.

For example, the composition may be applied by spray coating, spin coating, gravure coating, curtain coating, dip coating, slot-die coating, rod or bar coating, doctor-blade coating, flowcoating, which involves controlled gravity flow of a coating over the substrate, or the like.

Should the disclosure of any patents, patent applications, and publications which are incorporated herein by reference conflict with the description of the present application to the extent that it may render a term unclear, the present description shall take precedence.

### EXPERIMENTAL PART

The disclosure will now be illustrated with working examples, which is intended to illustrate the working of disclosure and not intended to take restrictively to imply any limitations on the scope of the present disclosure. Other examples are also possible which are within the scope of the present disclosure.

### Reference Products:

Tetraacetylethylenediamine (TAED): CAS 10543-57-4
1,4,7-trimethyl-1,4,7-triazacyclononane (TMTACN): CAS 96556-05-7
Sodium 2,3-dihydroxynaphthalene-6-sulfonate: CAS 135-53-5
Caffeic acid: CAS 331-39-5
Ellagic acid: CAS 476-66-4
2,5-Dihydroxy-1,4-benzoquinone (DHBQ): CAS 615-94-1
1,8-Dimethyl-1,4,8,11-tetraazacyclotetradecane: CAS 214078-92-9
Manganese(II) chloride tetrahydrate: CAS 13446-34-9Di[manganese (1+)],
bis(octahydro-1,4,7-trimethyl-1H-1,4,7-triazonine kN¹, kN⁴, kN⁷)-tri-μ-oxo-, bis[ethanoate (1-)](Dragon complex): CAS 916075-10-0
Sodium percarbonate: CAS 15630-89-4
Trisodium citrate hexahydrate: CAS 6858-44-2
Sodium carbonate: CAS 497-19-8
Sodium slicate: CAS 6834-92-0
Sodium sulfate: CAS 7757-82-6

### Example 1 Preparation of Complex 1

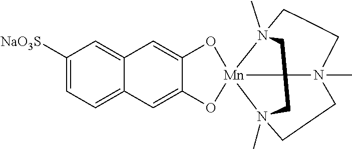

In a schlenk reaction flask, MnCl₂.4H₂O (395 mg) was added inside and protected by N₂ atmosphere. 100 ml Methanol was injected inside via syringe. Then TMTACN (342 mg) was injected and stirred at room temperature. In a separate beaker, the sodium 2,3-dihydroxynaphthalene-6-sulfonate (524 mg) was dissolved in 20 ml Methanol and NaOH (80 mg) was added and stirred for 2 mins. The solution was injected via syringe in the flask and the final mixture was stirred for 4 h at 40° C. The precipitate was obtained by filtration and can be recrystallized in ethanol if necessary. The complex formation was confirmed by LC-MS (m/z=464.1086).

### Example 2 Preparation of Complex 2

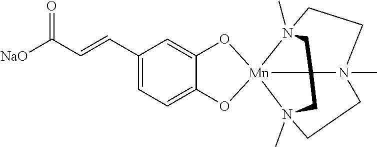

According to the same procedure of example 1, with caffeic acid (360.3 mg) to replace sodium 2,3-dihydroxynaphthalene-6-sulfonate (524 mg) and 120 mg NaOH instead of 80 mg. The complex was confirmed by LC-MS (m/z+H)=405.1486.

### Example 3 Preparation of Complex 3

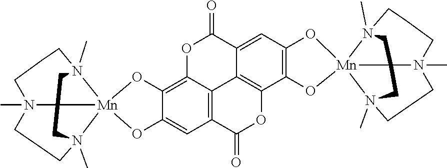

According to the same procedure of example 1, with ellagic acid (302.2 mg) to replace sodium 2,3-dihydroxynaphthalene-6-sulfonate (524 mg) and 160 mg NaOH instead of 80 mg. The complex was confirmed by LC-MS (m/z=750.1990 and 375.0991).

### Example 4 Preparation of Complex 4 (Diethyl-cyclam)Mn(DHBQ)(PF₆) (Comparison Example)

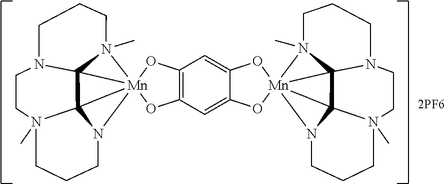

According to the procedure described in U.S. Pat. No. 9,102,903B2, the complex was obtained as gray powder.

### Example 5 the Laundry Bleaching Performance

Into a beaker with 1 L hard water (250 mg Ca/L) at 40° C., standard detergent GB/T 13174-2008 (2.0 g) was added and the mixture was stirred for 3 mins, at a temperature of 40° C. The complex 1 (5 mg) and sodium percarbonate (800 mg) were added, consecutively, at a temperature of 40° C. Finally, the stained fabric was added and stirred for 30 mins (200 rpm) at a temperature of 40° C. After the bleaching, the bleached fabric pieces were washed with tap water for three times at ambient temperature, squeezed and dried naturally.

The bleaching performance was evaluated by CIELAB Color i7 spectrophotometer. Color difference (ΔE) before and after bleaching is calculated with:

$$Δ E = \sqrt{{( \text{?} - \text{?} )}^{2} + {( {a}_{bleached} - {a}_{original} )}^{2} + {( {b}_{bleached} - {b}_{original} )}^{2}}$$

$$\text{?} \text{indicates text missing or illegible when filed}$$

Results with tea stained fabric and catalysts/activators are expressed in Table 1.

TABLE 1

| | ΔE (C-H028) |
|---|---|
| Bleaching agents | (Tea stained) |
| Detergent (2.0 g) | 25.7 |
| TAED (400 mg) | |
| Sodium percarbonate (800 mg) | |
| Detergent (2.0 g) | 11.5 |
| Detergent (2.0 g) | 19.6 |
| Sodium percarbonate | |
| (800 mg) | |
| Detergent (2.0 g) | 24.9 |
| TMTACN (5 mg) | |
| Sodium percarbonate | |
| (800 mg) | |
| Detergent (2.0 g) | 27.9 |
| Complex 1(5 mg) | |
| Sodium percarbonate | |
| (800 mg) | |
| Detergent (2.0 g) | 26.1 |
| Complex 2 (5 mg)Sodium percarbonate | |
| (800 mg) | |
| Detergent (2.0 g) | 29.2 |
| Complex 3 (5 mg)Sodium percarbonate | |
| (800 mg) | |
| Detergent (2.0 g) | 27.3 |
| Dragon complex (5 mg)Sodium | |
| percarbonate | |
| (800 mg) | |
| Detergent (2.0 g) | 20.7 |
| Complex 4 (comparison example) (5 | |
| mg)Sodium percarbonate | |
| (800 mg) | |

Tea stained fabric reference: CFT B.V C-H028 standard material Tea—Circular Stain Ø=5 cm on Woven Cotton.

It appears the composition permits to obtain better bleaching properties on fabrics while using a significant lower amount metal complex (5 mg) of the invention in comparison with TAED (400 mg) known as a reference on the market and even better than the dragon complex of super high price with the drawback of fabric damage.

### Example 6 the Laundry Bleaching Performance

Into a beaker with 1 L hard water (250 mg Ca/L) at 40° C., optionally 2.0 g of standard detergent GB/T 13174-2008 was added and the mixture was stirred for 3 mins, at a temperature of 40° C. The complex 3 (5 mg) and sodium percarbonate (800 mg) were added, consecutively, at a temperature of 40° C. Finally, the stained fabric was added and stirred for 30 mins (200 rpm) at a temperature of 40° C. After the bleaching, the bleached fabric pieces were washed with tap water for three times at ambient temperature, squeezed and dried naturally.

Results with tea stained fabrics and complex 3 are expressed in Table 2.

TABLE 2

| | ΔE |
|---|---|
| Formulations | (Tea stained) |
| Water only | 2 |
| Water and detergent | 11.5 |
| Water, sodium percarbonate and no detergent | 14.3 |
| Water, complex 3, sodium percarbonate and no detergent | 23.8 |

It appears the composition of the invention permits to obtain higher bleaching properties on fabrics without detergent in comparison with the bleaching agent alone.

### Example 7 the Auto Dishwashing Bleaching Performance

The dish washing procedure follows the IKW test method (reference: Nitsch, Ch, and G. Huttmann. SOFW JOURNAL 128.5 (2002): 23-29.).

### The Homemade Tea Cups Preparation Procedure:

Mix 2 litres of synthetic water and bring it to the boil. Pour boiling water on 30 g of tea in an open container and leave it to brew for 5 minutes. Then pour the tea through a strainer into another temperature-controlled vessel.

The clean cups are filled with 100 ml of tea such that the temperature of the tea in the cups is 85° C. The initial temperature of the poured tea is about 93° C. Remove 20 ml of tea every 5 minutes with a pipette until all the cups are empty (5 times). This process is then repeated once more with freshly brewed tea.

The components of the auto dishwashing (hereinafter ADW) formulation are presented in Table 3, and firstly the components in solid state (Trisodium citrate hexahydrate, sodium carbonate, sodium silicate, Mirapol® Surf-S Pfree Powder, sodium percarbonate, sodium sulfate) were mixed sufficiently and put into the ADW machine washing product chamber. Then the components in liquid form (Antarox LF54 and Rhodoline 111) were weighed into the rince aid chamber in ADW machine.

TABLE 3

| Component | g |
|---|---|
| Trisodium citrate hexahydrate (Sinopharm.) | 30 |
| Sodium carbonate (Sigma-Aldrich) | 20 |
| Sodium silicate (Sigma-Aldrich) | 10 |
| Mirapol ® Surf-S Pfree Powder (Solvay) | 1 |
| Sodium percarbonate (Alfa-Aesaer) | 8 |
| Rhodoline 111 (Solvay) | 8 |
| Antarox LF54 (Solvay) | 3 |
| Sodium sulfate (Sigma-Aldrich) | 10 |

The ballast soil preparation was described in Nitsch, Ch, and G. Huttmann. SOFW JOURNAL 128.5 (2002): 23-29. The composition is in Table 4.

TABLE 4

| Constituents | Raw material | wt. % |
|---|---|---|
| Fat | Vegetable oil (e.g. Aro, Metro) | 31.6 |
| | Margarine (e.g. Homann, | 6.3 |
| | Allgäu-Margarine) | |
| | Lard (e.g. Laru, Lagensiepen, &Ruckebier) | 6.3 |
| | Deep-frying fat (e.g. | 6.3 |
| | Aro, Metro, semi-liquid) | |
| Protein | Whole egg (e.g. Wiesenhof) | 15.8 |
| | Cream (e.g. Debic, UHT, cream, 32% fat)) | 9.4 |
| | Whole milk, pasteurized, 3.5% fat | 6.3 |
| Other powdered | Potato starch (e.g. | 2.2 |
| solid | Superior LXJ 72, Emsland) | |
| | Gravy (e.g. Knorr) | 1.7 |
| | Wheat flour (e.g. Diamant-Mehl, type 405) | 0.6 |
| | Quark powder (e.g. Dr. Otto Suwelack, | 0.6 |
| | Billerbeck) | |
| | Benzoic acid > 99.9% (chemical supplier) | 0.3 |
| Other | Tomato ketchup (e.g. Kühne) | 6.3 |
| | Mustard (e.g. Löwensenf“Extrascharf”) | 6.3 |

In the auto dishwasher (Siemens SK23E210TI), 9 g homemade ADW formulation powder and 10 mg Mn complex were added in the detergent container, the tea stained tea cups and 50 g frozen ballast soil in small bottle were put inside the dishwasher. The Eco-50° C. program was chosen.

After the prewash (20 mins), the detergent container was opened automatically and After 15 mins period, the bleached tea cup was rinsed and dried naturally for visually evaluation (mark 0-10 indicated no performance to excellent performance).

The Table 5 gave the ADW performance for different catalysts/activators for two different bleaching periods.

TABLE 5

| Composition | Performance after 15 mins bleaching |
|---|---|
| Homemade Formulation 9 g | 5 |
| TAED 0.5 g | |
| Homemade Formulation 9 g | 8 |
| Dragon complex 10 mg | |
| Homemade Formulation 9 g | 8 |
| Complex 1 10 mg | |
| Homemade Formulation 9 g | 5 |
| TMTACN 10 mg | |
| Homemade Formulation 9 g | 7 |
| Complex 2 10 mg | |
| Homemade Formulation 9 g | 9 |
| Complex 3 10 mg | |
| Homemade Formulation 9 g | 5 |
| Complex 4 10 mg | |
| Homemade Formulation 9 g | 3 |

### Example 8 the Auto Dishwashing Bleaching Performance

Instead of Homemade ADW formulation in Example 7, the ‘Finish® Quantum’ tablet without catalyst (‘Finish® Quantum’ Base, ˜11 g) has also been used as base formulation to evaluate the auto dishwashing performance of different complexes.

The procedure is the same in Example 7 and the results are presented in Table 6.

TABLE 6

| Composition | Performance after 15 mins bleaching |
|---|---|
| ‘Finish ® Quantum’ Base | 7 |
| TAED 0.5 g | |
| ‘Finish ® Quantum’ Base | 9 |
| Dragon complex 10 mg | |
| ‘Finish ® Quantum’ Base | 9 |
| Complex 1 10 mg | |
| ‘Finish ® Quantum’ Base | 7 |
| TMTACN 10 mg | |
| ‘Finish ® Quantum’ Base | 8 |
| Complex 2 10 mg | |
| ‘Finish ® Quantum’ Base | 10 |
| Complex 3 10 mg | |
| ‘Finish ® Quantum’ Base | 6 |
| Complex 4 10 mg | |
| ‘Finish ® Quantum’ Base | 5 |

Obviously, the complexes prepared increased significantly the bleaching performance of homemade ADW formulation and showed better performance than TAED, and for complex 3, even better performance obtained than dragon complex.

### Example 9 the Curing Performance

The performance of coating comprising manganese complexes as the oxidative crosslinking catalyst was evaluated based on the waterborne alkyd paints purchased from ‘Chengyang Waterborne’.

Under mechanic stirring, 10 mg corresponding additive was added into 100 g alkyd paints and stirred for 10 mins at 500 rpm. Then a 30 μm thickness film was applied on the glass surface and the drying time was recorded on the BYK drying time recorder BYK 2710.

The results were shown in Table 7.

TABLE 7

| Additive | Drying time | |
|---|---|---|
| No additional catalyst | 12 | h |
| Complex 1 | 8 | h |
| Complex 2 | 8 | h |
| Complex 3 | 6 | h |

It can be seen that the oxidative crosslinking catalyst shows excellent performances in comparison with the paint without the oxidative crosslinking catalyst and increase the curing much faster.

1. A metal complex, having the general formula (I):
Mᵢ(L₁)(L₂)ᵢ (I)
wherein:
M is a transition metal;
i is an integer ranging from 1 to 10;
L₁ is a ligand having the general formula (II) or (III): 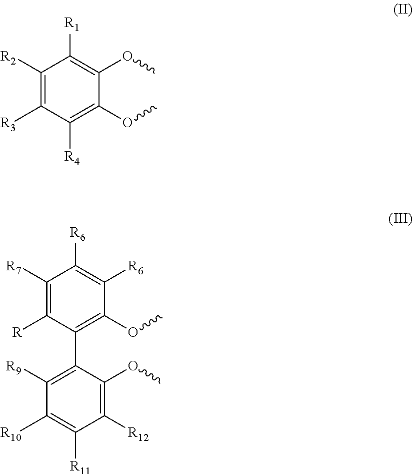
wherein:
R₁, R₂, R₃, R₄, R₅, R₆, R₇, R₈, R₉, R₁₀, R₁₁, or R₁₂, independently from each other, are selected from the group comprising: H, hydrocarbyl radical, halide, —OH, —NO₂, —CN, —OR′, —O—CO—R′, —COR′, —CO—OR′, —NR′R″, —CONR′R″, —NR′—COR″R′″, —NR′—CO—NR″R′″, —SO₃X, —SO₄X, —COOX, and at least one of R₁ to R₄, or one of R₅ to R₁₂ is selected from the group consisting of: —CN, —OR′, —O—CO—R′, —COR′, —CO—OR′, —NR′R″, —CONR′R″, —NR′—COR″R′″, —NR′—CO—NR″R′″, —SO₃X, —SO₄X or —COOX; or
five or six membered ring constituted with two or more groups of R₁, R₂, R₃, R₄ and the skeleton of aromatic ring; or
five or six membered ring constituted with two or more groups of R₅, R₆, R₇, R₈, R₉, R₁₀, R₁₁, R₁₂, optionally a —OH group, and the skeleton of aromatic ring;
R′, R″ and R′″, independently from each other, are H or hydrocarbyl radical;
X is selected from the group comprising H, alkali metal cation, alkaline earth metal cation or ammonium;
L₂ is a ligand having the formula (IV): 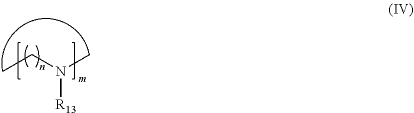
wherein:
R₁₃ is a hydrocarbyl radical, and each of the R₁₃ groups may be the same or different;
n is an integer being 1, 2 or 3;
m is an integer being from 2, 3, 4 or 5.

2. The metal complex according to claim 1 wherein R₁₃ is a C₁-C₃₀-hydrocarbyl radical.

3. The metal complex according to claim 1 wherein R₁₃ is a C₁-C₁₅-hydrocarbyl radical.

4. The metal complex according to claim 1, wherein R₁₃ is straight-chain, branched or carries one or more substituents.

5. The metal complex according to claim 1, wherein the substructure L₂ of the formula (IV) is chosen in the group constituted by triazacycloalkanes and tetraazacycloalkanes.

6. The metal complex according to claim 1, wherein the substructure L₂ of the formula (IV) is chosen in the group constituted by: 1,3,5-trimethyl-1,3,5-triazacyclohexane; 1,3,5-trimethyl-1,3,5-triazepane; 1,3,5-trimethyl-1,3,5-triazocane; 1,3,5,7-tetramethyl-1,3,5-triazocane; 1,3,6-trimethyl-1,3,6-triazocane; 1,3,5-trimethyl-1,3,5-triazonane; 1,3,6-trimethyl-1,3,6-triazonane; 1,3,6,8-tetramethyl-1,3,6-triazonane; 1,4,7-trimethyl-1,4,7-triazacyclononane; 1,3,5-trimethyl-1,3,5-triazecane; 1,3,6-trimethyl-1,3,6-triazecane; 1,3,7-trimethyl-1,3,7-triazecane; 1,3,5,7-tetramethyl-1,3,7-triazecane; 1,3,5,7,9-pentamethyl-1,3,7-triazecane; 1,3,5,7-tetramethyl-1,3,5-triazecane; 1,4,7-trimethyl-1,4,7-triazecane; 1,4,7,9-tetramethyl-1,4,7-triazecane; 1,4,7-trimethyl-1,4,7-triazacycloundecane; 1,4,8-trimethyl-1,4, 8-triazacycloundecane; 1,4,6,8-tetramethyl-1,4,8-triazacycloundecane; 1,4,7-trimethyl-1,4,7-triazacyclododecane; 1,4,7,10-tetramethyl-1,4,7,10-tetraazacyclododecane; 1,4,7,10-tetramethyl-1,4,7-triazacyclododecane; 1,4,8-trimethyl-1,4,8-triazacyclododecane; 1,5,9-trimethyl-1,5,9-triazacyclododecan; 1,3,5,9-tetramethyl-1,5,9-triazacyclododecane; and 2-methyl-1,4,7-trimethyl-1,4,7-triazacyclononane preferably 1,4,7-trimethyl-1,4,7-triazacyclononane.

7. The metal complex according to claim 1, wherein the metal complex is prepared by mixing metal compound, ligand L₁ and ligand L₂ with molar ratio of t:1:t, wherein t is ranging from the number of 1 to 10.

8. The metal complex according to claim 1, wherein the transition metal atom is selected from the group comprising V, Mn, Fe, Co, Ni and Cu.

9. A composition comprising at least:
(1) a metal complex according to claim 1,
(2) a source of hydrogen peroxide.

10. The composition according to claim 9, wherein the source of hydrogen peroxide is selected from the group consisting of: alkali metal peroxides, organic peroxides, inorganic persalts, and their precurors.

11. The composition according to claim 9, wherein the composition comprises from 1 to 50% by weight of the source of hydrogen peroxide, with respect to the total weight of the composition.

12. The composition according to claim 9, wherein the composition further comprises water.

13. The composition according to claim 9, wherein the composition further comprises a detergent.

14. The composition according to claim 9, wherein the composition comprises from 0.00001 to 1.0% by weight of the metal complex, with respect to the total weight of the composition.

15. A formulation comprising at least a detergent, a metal complex of formula (I) according to claim 1, and optionally a source of hydrogen peroxide.

16. The formulation according to claim 15, wherein said formulation comprises from 0.0001 to 0.1 by weight of the metal complex of formula (I) with respect to the total weight of the formulation.

17. An extemporaneous composition comprising at least:
a first composition comprising at least a detergent and a metal complex of formula (I) according to claim 1, notably in a solid form, and
a second composition comprising at least a source of hydrogen peroxide, separate from the first composition; the second composition being capable of being mixed with the first composition.

18. A method for treating a substrate, the method comprising treating the substrate with the metal complex of formula (I) according to claim 1.

19. A method for treating a substrate, the method comprising treating the substrate with the composition according to claim 9.

20. The method according to claim 18, wherein the substrate is fabric.

21. A method for treating a substrate, the method comprising applying to the substrate, in an aqueous medium, a composition comprising at least the metal complex of formula (I) according to claim 1.

22. A method of treating tableware comprising treating tableware with a metal complex of formula (I) according to claim 1.

23. A method of treating tableware comprising treating tableware with the composition according to claim 9.

24. A method for washing tableware, comprising treating a stained tableware with the composition according to claim 9.

25. The method according to claim 24, wherein the tableware is treated in an automatic dishwasher.

26. A method for treating a substrate, comprising at least:
a) having available a composition comprising at least a detergent and a metal complex of formula (I),
b) having available a source of hydrogen peroxides, separate from the composition a)
c) bringing the composition a) extemporaneously into contact with the source of hydrogen peroxide, and
d) bringing the mixture of c) into contact with the substrate.

27. A resin composition comprising at least:
(a) a metal complex according to claim 1;
(b) a resin.

28. A method of curing a resin, the method comprising curing the resin with the metal complex according to claim 1.
